(19) United States
(12) Patent Application Publication
(10) Pub. No.: US 2009/0187733 A1
(43) Pub. Date: Jul. 23, 2009

(54) Virtual Configuration Management for Effiicient Use of Reconfigurable Hardwware

(76) Inventor: Tarek El-Ghazawi, Vienna, VA (US)

Correspondence Address: JUNEAU PARTNERS, P.O. BOX 2516, ALEXANDRIA, VA, 22301, US

(21) Appl. No.: 11/685,763

(22) Filed: Mar. 13, 2007

Related U.S. Application Data
(60) Provisional application No. 60/781,377, filed on Mar. 13, 2006.

(51) Int. Cl. G06F 15/76; G06F 9/06

(52) U.S. Cl. 712/15; 712/E09.003

(57) ABSTRACT

Reconfigurable Computers (RCs) can leverage the synergism between conventional processors and FPGAs by combining the flexibility of traditional microprocessors with the parallelism of hardware and reconfigurability of FPGAs. Multiple challenges must be resolved to develop efficient and viable solutions of reconfigurable computing applications. This paper has developed virtual configuration management techniques for discovering and exploiting spatial and temporal processing locality at run-time for RCs. The developed techniques extend cache and memory management techniques to reconfigurable platforms and augmented them with other concepts such as data mining using association rule mining (ARM). We have demonstrated the applicability and the effectiveness of the proposed concepts by applying them to representative image processing applications.

Simulations, as well as emulation using the Cray XD1 reconfigurable high-performance computer were used for the experimental study. The results show a significant improvement in performance using the proposed techniques. This improvement can be assessed by computing the speedup. This speedup shows that the proposed segmentation technique is almost twice as fast as the function-by-function scenario and more than three times faster than the full reconfiguration scenario depending on the working conditions. The physical restrictions on pages size have been overcome by using segmentation. Segmentation achieved better performance than paging by a factor of 30%. Preliminary studies of the concept of dual-track execution have been investigated. The results have shown modest improvement of about 29%. Future work will include investigating more sophisticated dual track execution policies that may even be targeted to produce even better performance.

### PRIORITY

This application claims benefit under 119(e) of 60/781,377 filed 13 Mar. 2006.

### STATEMENT OF GOVERNMENT INTEREST

There are no government grants involved in development of this technology.

### BACKGROUND

Computer architectures with both reconfigurable processors and traditional microprocessors have been gaining rising attention and many such systems are now available. Such systems can adapt the overall system to the underlying applications at run-time. However, due to the limited reconfigurable resources, not all needed functionalities can be implemented in the same time. Previous work has considered swapping hardware functions on either a function-by-function basis or by reconfiguring the whole chip. Initially we have proposed a configuration management technique based on grouping related functions into fixed size blocks (pages), where more than one page can be placed on the reconfigurable hardware. Pages are swapped in and out as necessary during application execution. However, paging can introduce physical artificial constraints on the functions grouping decision. Therefore, we are also proposing a segmentation technique, where segments are variable size blocks, and as in paging more than one segment can be accommodated simultaneously on the reconfigurable hardware.

Reconfigurable Computers (RCs) have recently evolved from accelerator boards to stand-alone general-purpose RCs and parallel reconfigurable supercomputers [1, 2]. Examples of such supercomputers are the Cray XD1, SRC, and the SGI Altix with FPGA bricks [2]. Although Reconfigurable Computers can leverage the synergism between conventional processors and FPGAs, there exist multiple challenges that must be resolved [3]. One of the challenges is that some large circuits require more hardware resources than what is available, and the design cannot fit in a single FPGA chip. One solution to this problem is run-time reconfiguration (RTR). RTR allows large modular applications to be implemented by reusing the same configurable resources. Each application is implemented as a set of hardware functions (modules) that do not need concurrent execution. Each hardware function is implemented as a partial configuration which can be uploaded onto the reconfigurable hardware as it is needed to implement the application. Partial reconfiguration allows configuring and executing a function onto an FPGA without affecting other currently running functions, which can increase device utilization. On the other hand, the problem of the reconfiguration time overhead has always been a concern in RTR. As configuration time could be significant, eliminating, reducing, or hiding this overhead becomes very critical for reconfigurable systems. Locality of references has been used to provide high average memory bandwidths in conventional microprocessor-based architectures through caching and memory hierarchy techniques. A parallel concept can be defined within the context of reconfigurable computing [3, 4]. Considering applications that are built out of small reusable functional modules, the use of such modules can exhibit spatial and temporal localities. In this context, spatial locality refers to the fact that certain hardware functions may be correlated in the way they are used by applications and therefore appear together during execution. Therefore, it can be also viewed as semantic locality. Temporal locality, mainly due to loops, refers to the fact that functions used in the past may be used again in the near future.

To contrast these from the standard address-based locality of references, we call them processing spatial locality, processing temporal locality, or processing locality in general. Li and Hauck [4, 5] proposed several techniques to cache the configuration for different FPGA models, e.g. single context and partial RTR (PRTR). In the single context scenario, functions of an application are arranged into blocks each of which has enough functions to fill the entire chip. The blocks are configured in the deterministic sequence needed by the application based on the a priori knowledge about the application. This method works well for a single application. A simulated annealing algorithm was used to create the groups, out of an application. This method assumes that the configurations sequence is known in advance. They also proposed a method for creating the groups based on the statistical behavior of the applications. However, this method considers pair-wise function correlations. This guarantees that each newly added function appears with every function, which has been pre-selected in the group, individually. It does not, however, consider probability that all functions of the same group may appear together. In the PRTR scenario, each function is configured or replaced on a function-by-function basis, based on the application needs. Least-Recently-Used (LRU) replacement technique was used to replace the victim function. In the former technique, RTR, spatial processing locality is well exploited. In the latter, PRTR, only temporal processing locality is exploited. In our previous work we have proposed a configuration management technique based on grouping related functions into fixed size blocks (pages)[6]. Pages are swapped in and out at run time as necessary. However, paging can introduce physical artificial constraints on the functions grouping decision. In this work, we propose a more general virtual-memory-like technique called virtual configuration management. This technique is suitable for multitasking and for cases of single applications that can change the course of processing in a non-deterministic fashion based on data. It discovers related functions and groups them into variable size blocks (segments), where multiple blocks can be configured on a chip simultaneously. To avoid excessive delays and starvation, this execution model allows functions to be performed using either the microprocessor or the reconfigurable hardware. Thus, two libraries, hardware and software, of identical functionality are used to support the reconfigurable chip and microprocessor, respectively. For example, consider FIG. 1, the hardware and the software libraries would have separate implementations for fft, inverse fft, and matrix multiply. By grouping only related hardware functions that are typically requested together into segments, processing spatial locality can be exploited. In addition, temporal locality can consecutively be exploited through replacement techniques. Data mining techniques are used to group related functions into segments. Standard, replacement algorithms as those found in caching can also be considered. Simulation and emulation, using the Cray XD1 reconfigurable high-performance computer, were used for the experimental study. The results showed a significant improvement in performance using the proposed technique.

### Virtual Reconfiguration Management

Virtual memory is the operating system abstraction that gives the programmer the illusion of an address space being larger than the physical address space. Virtual memory can be implemented using either paging or segmentation. In paging, the task logical address space is subdivided into fixed-size pages. In segmentation, the task logical address space is subdivided into logically related modules, called segments. Segments are of arbitrary size, each one addressed separately by its segment number. The same concept can be leveraged to adaptive computing by considering the FPGA as a cache memory of configurations (functions). Configurations are retained in the FPGA itself until they are required again. Configurations that are going to be needed in the near future can be predicted by using the processing locality principles, and then, the System configures them into the FPGA before they are actually requested

### Motivations

There exist multiple challenges that must be resolved in order to develop efficient solutions for reconfigurable computing systems. One limitation of RCs is that some large applications require more hardware resources than are available, and the complete design cannot fit into a single FPGA chip. This can be solved using run-time reconfiguration (RTR). RTR is an approach that divides applications into a number of modules with each module implemented as a separate circuit. These modules are uploaded onto the reconfigurable hardware as they become needed to implement the application. However, this also increases the reconfiguration latency overhead, the time needed to download the binary bitstream into an FPGA. Reconfiguration latency can offset the performance improvement achieved by hardware acceleration when RTR is considered. For example, applications on some systems spend 25% to 98.5% of their execution time performing reconfiguration [3, 4]. Reconfiguration methods in current systems are not fully dynamic. Although reconfiguration in these systems happens at runtime, it follows a fixed (static) schedule that has been determined off-line. These approaches cannot support general-purpose multitasking cases as well as single large tasks that are data-dependent which results in non- deterministic processing requirements. This is because the actual processing needs in these cases depend on the dynamic mix of the randomly arriving tasks.

### SUMMARY

In a preferred embodiment is provided a computer architecture with reconfigurable processors, wherein the overall system is adapted to the underlying applications at run-time, wherein not all needed functionalities can be implemented at the same time, the improvement comprising: a configuration management technique based on grouping related functions into fixed size blocks (pages), said Pages are swapped in and out as necessary during application execution, and to address the problem that paging can introduce physical artificial constraints on the functions grouping decision, a technique, called virtual configuration management, that discovers related functions and groups them into variable size blocks (segments), wherein a dual-track execution is provided which allows functions to be performed using either the microprocessor or the reconfigurable hardware. The reconfigurable hardware is sufficiently large such that more than one page or more than one segment can be configured simultaneously.

In another preferred embodiment is provided where the locality of spatial and temporal processing is exploited in the reconfigurable processor simultaneously.

In another preferred embodiment is provided, where it further uses block replacement strategies to exploit both spatial and temporal processing locality simultaneously.

In another preferred embodiment is provided wherein the virtual configuration model can provide an increase in processing speed of over previous techniques.

In another preferred embodiment is provided wherein the invention is a technique to increase the speed of executing complex functions in a computer architecture by allowing functions to be performed using either the microprocessor or the reconfigurable hardware, and executing the most efficient use of the two mechanisms, as described herein.

In another preferred embodiment is provided a method of scheduling function processing between software and hardware in a computer architecture using virtual configuration management, as described herein.

In another preferred embodiment, a system capable of performing the method of any of claims 1, 2, 3, 4, 5, or 6 is provided.

In another preferred embodiment, computer readable media containing program code for performing the method of any of claims 1, 2, 3, 4, 5, or 6 is provided.

In another preferred embodiment, the media includes wherein the program code is written in software code languages or hardware description languages.

### BRIEF DESCRIPTION OF THE DRAWINGS

FIG. 1 is an application example.

FIG. 2 is an example of an A priori algorithm, a database with 4 transactions

FIG. 3 shows a Hash Function

FIG. 4 shows a Hash table.

FIG. 5 is a diagram and shows Blocks Table and Hash Table Contents during algorithm execution

FIG. 6 is a flowchart and shows a RTRM algorithm

FIG. 7 is a flowchart and shows a dual track algorithm

FIG. 8 is a flowchart and shows a dual track algorithm (look aside)

FIG. 9 shows a Cray CD1 system architecture

FIG. 10 shows a virtual FPGA model

FIG. 11 shows paging approach results

FIG. 12 shows segmentation approach results

FIG. 13 shows a speed up of dual track approach

FIG. 14 shows speed up vs. submission delay

FIG. 15 shows speed up vs. function size ratio

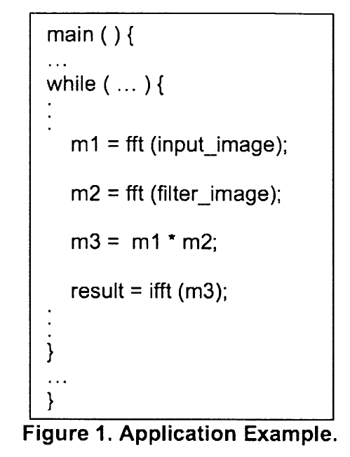

### DETAILED DESCRIPTION

### Assumptions

Partial run-time reconfiguration (PRTR) is considered in this work. In this scenario, the application is divided into a set of independent modules that need not to operate concurrently. Each module is implemented as a distinct configuration (function) which can be downloaded into the FPGA as necessary at run-time during application execution. Modules can be dynamically uploaded and deleted from the FPGA chip without affecting other running modules. Developing applications for PRTR requires both hardware and software programming. The application is written in a sequential high level language like C with calls to some HW functions (modules) from a predefined domain-specific hardware library. This maintains a familiar view seen by application scientists and programmers of conventional computers and reduces the development life-cycle of reconfigurable applications. At the reconfigurable hardware level, the HW functions library can be developed using a hardware description language. This Library contains the fine-grain processing basic building blocks (e.g. FFT, edge detection, and/or Wavelet decomposition) independent of the applications. Applications only deal with the application program interface (API) for the library.

### Segmentation and Association Rule Mining

Segmentation refers to the grouping of configurations (functions) into variable size segments. Segmentation is intended to exploit spatial processing locality and segment replacement is to exploit temporal locality. A segment is defined as a set of hardware functions to be placed at the same time on the device. Segmentation exploits spatial processing locality by arranging related HW functions into blocks. Spatial processing locality would arise from functions that are typically used together in a given application. For example, morphological operators such as opening and closing in image processing, and convolution and decimation in Discrete Wavelet Decomposition can be grouped together as one block. Data mining techniques, such as Association Rule Mining (ARM), are used to derive meaningful rules that can be useful for creating the blocks. These rules are used to determine the degree of correlation between the reconfigurable functions in order to group the highly related functions together into one block. At run-time, when the application requests any HW function, the system configures the entire segment. By configuring the entire segment, the system pre-fetches other functions that exist in the same block. When the application requests another function from the same block, which is likely, the system starts executing it directly without the need to configure a new bitstream. The segment size is not constrained, and it can be placed at any arbitrary empty location on the FPGA, unlike paging. In the paging scenario, the FPGA chip is divided into N fixed-size contiguous partitions (pages). A single block at any given point of time can be placed in any partition. The page size should be lager than or equal to the largest function size. However, blocks are constrained by the page size. Association Rule Mining (ARM) is an advanced data mining technique that is useful in deriving meaningful rules from a given data set [7]. It is frequently used in areas such as databases and data warehouses. Given a number of transactions of item sets, association rule discovery finds the set of all subsets of items that frequently occur in many database records or transactions, and extracts the rules telling us how a subset of items correlates to the presence of another subset. One example is the discovery of items that sell together in a supermarket. A management decision based on such findings could be to shelve these items close to one another. There are two important basic measures for association rules, support and confidence. Since the database is large and users are concerned about only those frequently purchased items, usually thresholds of support and confidence are pre-defined by users to drop those rules that are not as interesting or useful.

The A priori Algorithm

The a priori algorithm is an efficient association rule mining algorithm, developed by Agrawal et al, for finding all association rules [7]. The principle of this algorithm is that any subset of a frequent item set must be frequent. The first step of the algorithm is to discover all frequent items that have support above the minimum support required. The second step is to use the set of frequent items to generate the association rules that have high enough confidence.

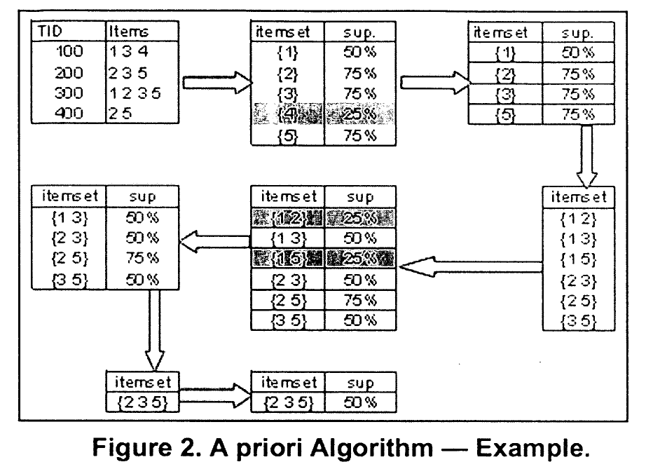

FIG. 2 shows an example of a database with 4 transactions, and it is required to find all rules with minimum support of 50%.

### 2.4. Segment Creation Algorithm

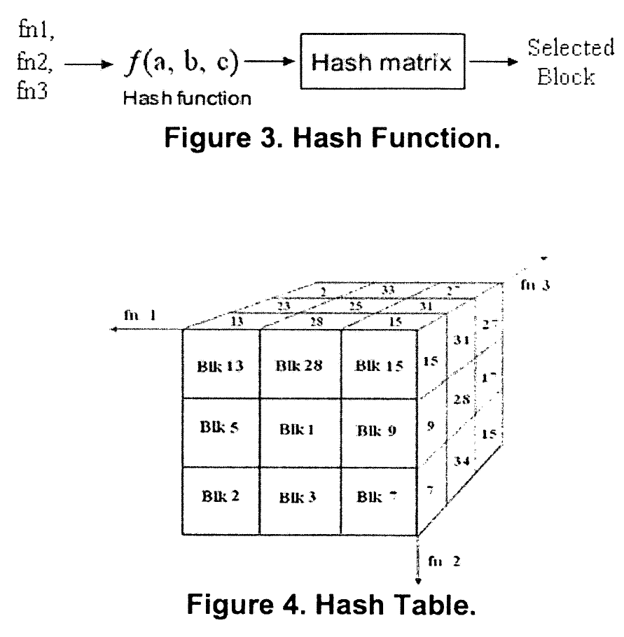

A segment is defined as a set of hardware functions to be placed at the same time on the device. These functions are highly correlated to each other. To create the segments, off-line software profiling of realistic executions is used to determine typical processing needs. Each application is considered as one transaction, and the executed hardware functions in that application are considered as the items. The profiler stores the transactions and their items in a table called transaction table. The a priori algorithm is executed off-line on the transaction table with a specified support and confidence. It generates a small table that has the necessary information (all rules between hardware functions) for the block generation. The algorithm generates a set of segments and a hash table to be used at run-time. In other words, when the system needs to execute a function that does not already exist on the FPGA chip; it uses the hash table to select the suitable segment and then upload it to the FPGA. Hashing is a process where data items are stored in a hash table data structure. The hash table is used to map the requested function to a certain block. Assuming that we have a hardware library of n functions; we define a hash matrix as a three-dimensional array. Each dimension has a length n. A hash function maps a key to the entry in the hash table that holds the data item referenced to by the key as shown in FIG. 3. The hash function takes the index of the most recently three hardware functions as input and returns the block that has highly related functions to these three functions. System can find the suitable block in a constant time O(1). Retrieving the suitable block takes one line of code:

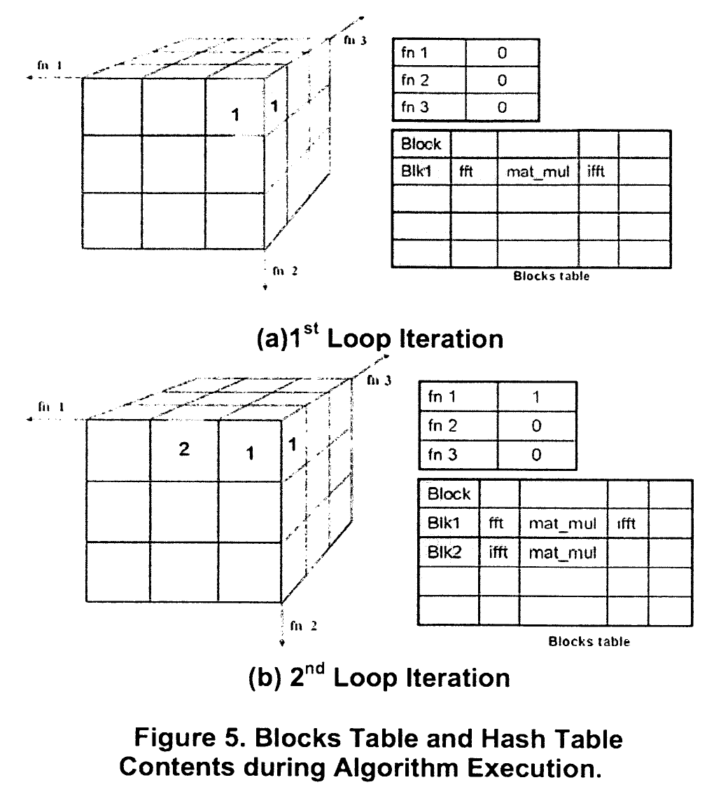

return hash_matrix[a][b][c].block

where a, b, c are the indexes of three hardware functions. FIG. 4 shows a 3D hash table example. For each entry of the hash table, the algorithm reads the three corresponding functions (one function for each index of the hash table), generates a new empty block, and inserts the first function into this block. Then, it adds the new block to the blocks table, and points the corresponding hash table entry to this block. After that, it searches for rules that contain either three, first and second, or only the first of these functions, preserving this search sequence, and adds other functions that appear in the retrieved rules to the new block. The algorithm stops adding functions to the block when the rules confidence reaches a minimum threshold. The confidence threshold value is pre-selected. To illustrate the segmentation mechanism, we consider an Image Processing hardware library that has 10 functions as shown in Table 1, and four applications written in a sequential high level language with calls to some HW functions from the library. The four applications are image convolution, image registration using exhaustive search, wavelet-based image registration, and hyperspectral dimension reduction. Table 2 shows the transaction table generated by profiling these applications. Table 3 shows the generated rules after applying ARM algorithms to the transaction table. Each row shows the related functions and the confidence of this relation. FIG. 5 shows the contents of both the blocks table and the hash table during the blocks creation process. Initially both tables are empty. After loop starts, it reads the first three functions which correspond to the fft function. The algorithm creates a new block (blk1), inserts fft into this block, and points the entry (0,0,0) of the hash table to blk1. Then, it searches the rules table for rules that have fft and its confidence is greater than or equal 25% (assuming that the confidence threshold is 25%). Rules 3, 4, and 12 satisfy the constraints. The algorithm adds other functions in these rules to blk1. The mat_mul and ifft functions are added to blk1 as shown in FIG. 5(a). In the 2nd loop iteration; the algorithm reads ifft, and fft. The algorithm creates a new block (blk2), inserts ifft into this block, and points the entry (1,0,0) of the hash table to blk2. Then, it searches the rules table for rules that have both ifft, and fft and confidence greater than or equal 25%. Rules 4, and 12 satisfy the constraints. The algorithm adds other functions in these rules to blk2 if the block can accommodate them. The function mat_mul is added to blk2 as shown in FIG. 5(b). The algorithm continues iterating till it completes filling the hash table. All grouped functions (segments) in the hash table are then compiled into final usable binary bitstream files.

TABLE 1
Image Processing Hardware Library

| Index | Functions | Description |
|---|---|---|
| 0 | fft | Discrete Fast Fourier Transform |
| 1 | Ifft | Inverse Discrete Fast Fourier Transform |
| 2 | mat_mul | Matrix Multiplication |
| 3 | DWT | Discrete Wavelet Transform |
| 4 | img_rot | Image Rotation |
| 5 | iDWT | Inverse Discrete Wavelet Transform |
| 6 | Sobel | Sobel edge detection Filter |
| 7 | median | Median Filter |
| 8 | hist | Histogram |
| 9 | corr | Correlation |

TABLE 2
Transaction Table

Application

| | | | | | | |
|---|---|---|---|---|---|---|
| Convolution | fft | fft | mat_mul | ifft | | |
| Ex_srch_img_reg | Img_rot | corr | | | | |
| Wavelet_img_reg | DWT | DWT | Img_rot | corr | Img_rot | corr |
| Dim-Reduction | DWT | IDWT | corr | hist | | |

TABLE 3
Generated Rules

| No | Items | Conf. |
|---|---|---|
| 1 | img_rot, corr | 50 |
| 2 | DWT, corr | 50 |
| 3 | fft, mat_mul | 25 |
| 4 | fft, ifft | 25 |
| 5 | ifft, mat_mul | 25 |
| 6 | iDWT, hist | 25 |
| 7 | DWT, iDWT | 25 |
| 8 | iDWT, corr | 25 |
| 9 | DWT, hist | 25 |
| 10 | hist, corr | 25 |
| 11 | DWT, img_rot | 25 |
| 12 | Ifft, fft, mat_mul | 25 |
| 13 | DWT, iDWT, hist | 25 |
| 14 | iDWT, hist, DWT | 25 |
| 15 | hist, iDWT, corr | 25 |
| 16 | DWT, iDWT, corr | 25 |
| 17 | corr, hist, DWT | 25 |
| 18 | corr, img_rot, DWT | 25 |
| 19 | img_rot, DWT, corr | 25 |
| 20 | corr, iDWT, hist, DWT | 25 |

### Run-Time Reconfiguration Management

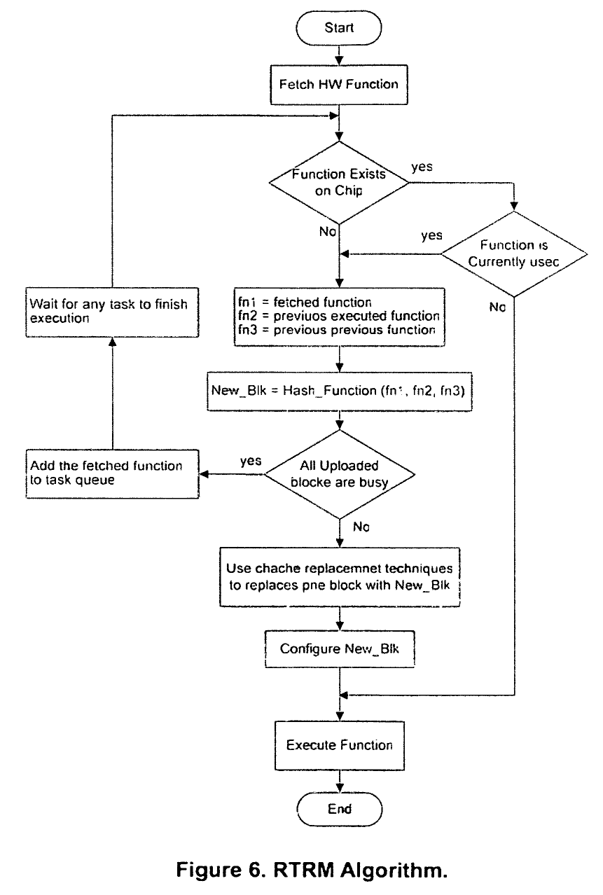

A middleware referred to as the run-time reconfiguration manager (RTRM) is used to integrate all of the concepts. The RTRM is responsible for receiving the incoming functions (HW function calls) and making the reconfiguration and scheduling decisions. FIG. 6 shows a simplified flow chart of RTRM algorithm. Upon receiving a request for a HW function from an application, the system checks whether this function already exists on the chip. When the function does exist and is not executing a function the system starts executing this particular function. If the function in not present on the FPGA or it is currently executing a function, the system faces a function fault. In this case, the system uses the requested function and the two previous executed functions from the same application as indexes to the hash table and retrieves the suitable segment. This segment has the group of functions that most likely appear with this sequence of functions. After that, the system has to choose a block (victim segment) to be removed from the FPGA to make room for the block that has to be brought in. While it would be possible, using page replacement algorithms, to pick a random segment to evict at each segment fault, the overall system performance is much enhanced if a segment that is not heavily used is chosen. If a heavily used segment is removed, it will probably have to be brought back in quickly, resulting in extra overhead (re-configuration time).The RTRM as suggested by most of the page replacement algorithms try to predict which segment will be referenced aftermost in future. The knowledge of past and/or the present behavior of the program is used to choose the victim segment. After choosing the victim segment, those algorithms dictate that the system configures this segment with the new block and starts executing the function. If all of the current uploaded blocks are currently executing other functions, the system adds the requested function to the function queue and waits for any function to finish its execution.

### Dual-Track Execution

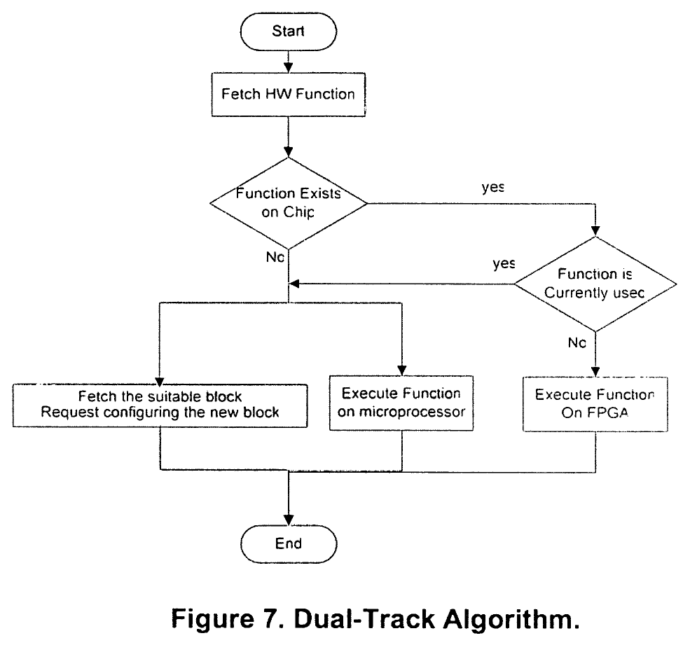

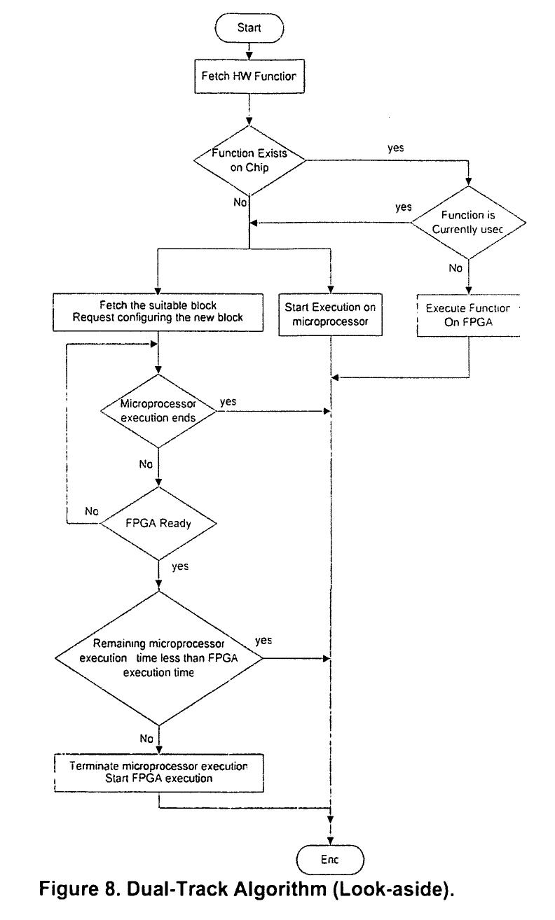

The use of both reconfigurable computing and conventional microprocessor resources could be adapted at run-time to achieve the best possible performance. One aspect of this adaptability is to allow the conventional processor to elect at run-time to perform some of the functions that are intended for execution on the reconfigurable engine, which can enhance the overall performance. Two dual-track techniques have been implemented technique with LRU. The 1st technique removes the functions queue from the system, and starts executing any requested function on the micro processor directly if the FPGA is not ready. FPGA is not ready, if the requested function does not already exist (configured) on the FPGA, or if the function is configured but another application is using it. The 2nd technique keeps the functions queue and starts executing the requesting function on the microprocessor if the FPGA is not ready. At the same time it adds the requested function to the function queue. Later, when the FPGA becomes ready, the system checks the remaining time to finish executing the function on the microprocessor and compares it with the execution time on FPGA plus the reconfiguration time, if reconfiguration is needed. The system then decides to continue executing on microprocessor or terminating it and starts executing on the FPGA. This technique is called look-aside. FIGS. 7, 8 show simplified flow charts of dual track algorithms.

### Experimental Study

The experimental verification of the proposed approaches has been performed by first implementing an image processing library. This hardware library has been realized for Xilinx Virtex-II device. Each function in the library operates at an execution rate of 100 MHz. Table 1 lists some of the implemented library functions. In addition, we have implemented some of the Image processing applications for RCs using this library. To support dual track execution, we have also implemented the library in software. Higher performance, in case of RC implementation, compared to Xeon 2.8 GHz implementation has been achieved [9, 10, 11]. Table 4 lists the implemented applications and their performance. Simulation and emulation, using the Cray XD1 reconfigurable high-performance computer, were used to verify our algorithms.

### Cray-XD1

The Cray XD1 machine [12, 13] is a multi-chassis system. Each chassis contains up to six nodes (blades). Each blade consists of two 64-bit AMD Opteron processors at 2.2 GHz, one Rapid Array Processor (RAP) that handles the communication, an optional second RAP, and an optional Application Accelerator Processor (AAP). Data from one Opteron is moved to the RAP via a Hyper Transport link. The AAP consists of a single Xilinx Virtex-II Pro XC2VP50-7 FPGA with a local memory of 16 MB QDR-II SRAM. The application acceleration subsystem acts as a coprocessor to the AMD Opteron processors, handling the computationally intensive and highly repetitive algorithms that can be significantly accelerated through parallel execution. In order to use the FPGA, the developer needs to produce the binary file that encodes the required hardware design, the binary bitstream file, using standard FPGA development tools. Cray provides templates in VHDL that allow fast generation of bitstreams. It also provides cores that interface the user logic to the Cray XD1 system.

TABLE 4
Applications Performance

Throughput (MB/s)

| Applications | Hardware | Software | Speedup |
|---|---|---|---|
| DWT | 199 | 13.76 | 14.5 |
| Dimension Reduction | 258 | 12.4 | 20.8 |
| Image Registration | 35 | 4.4 | 8 |
| Cloud Detection | 832 | 29 | 28 |

### Emulation Model

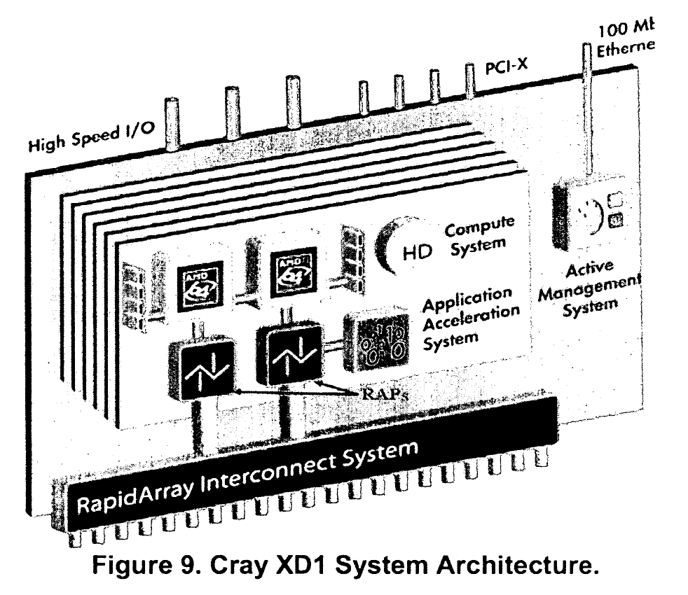

The proposed system assumes the FPGAs permit partial reconfiguration. Although recent generations of FPGAs support partial reconfiguration, most RCs vendors allow only full FPGA reconfiguration. This is the case on the used test bed, the Cray XD1. In order to overcome this problem, we have implemented an emulation model on Cray-XD1 machine. The Cray-XD1 has six compute nodes, and each node has an FPGA. We considered the six FPGAs as one FPGA device, and each FPGA can hold one block (page or segment) as shown in FIG. 9. This allows us to emulate partial reconfiguration, where we can reconfigure one FPGA (block) while other FPGAs (blocks) are executing other functions. We have removed all MPI communication overheads from the measured performance. A random job (application) generator was implemented to fire jobs to the RTRM and applications arrival was Poisson distributed. It randomly (uniformly) selects an image processing application from the applications list and inserts a delay (Poisson) before the next arrival. Each application requires on the average a few hardware functions. The average execution time for each hardware function is 7 ms. We have measured the average Speedup against classical hardware implementation function-by-function basis without caching. Throughput, mean response time, turn-around time, and average hit rate have been reported. Six replacement techniques for blocks replacement have been implemented. These techniques are, random, First In First Out (FIFO), the Least Recently Used (LRU), Second-Chance (CLOCK), Not Recently Used (NRU), and the optimal algorithms. The random job generator fires 400 applications from our image processing applications list. The average application length is 4 functions. The average function execution time is 7 ms. The average function size is 15% of the FPGA chip area. The average submission delay is 4 ms.

### Experimental Results

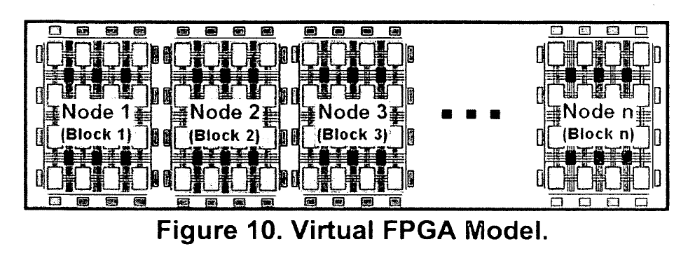

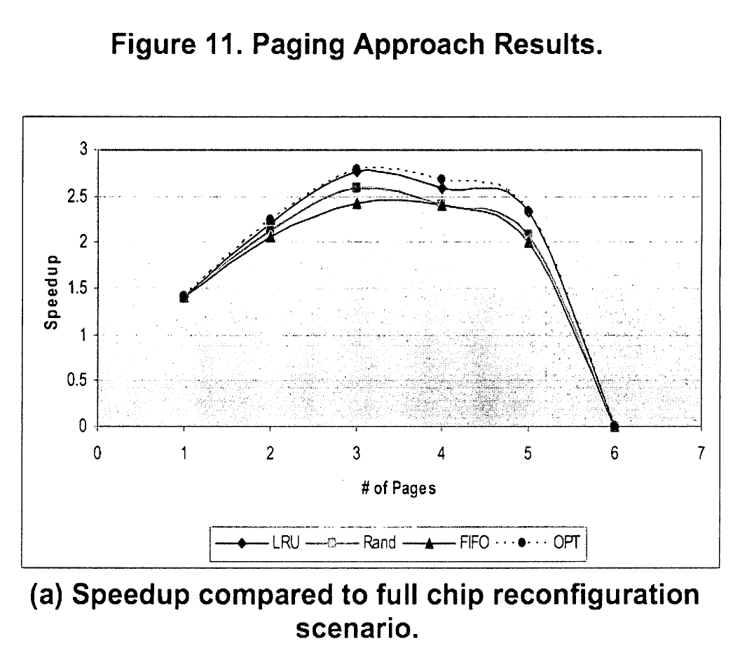

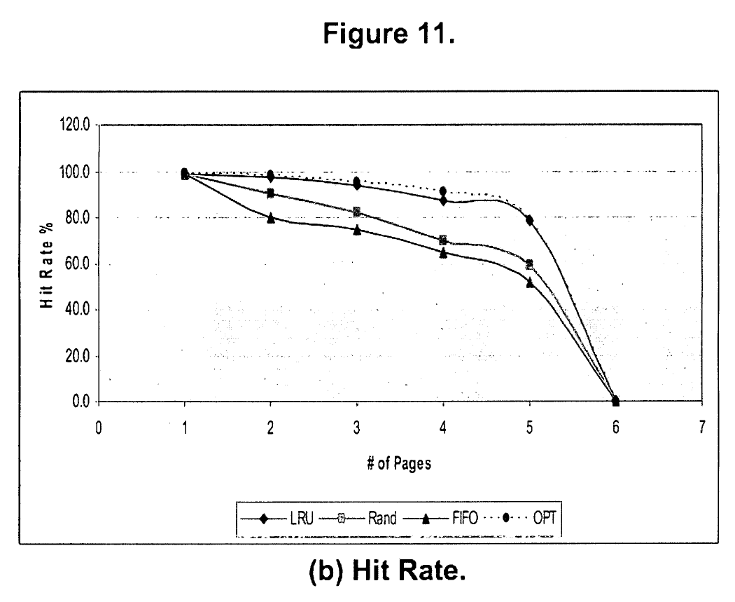

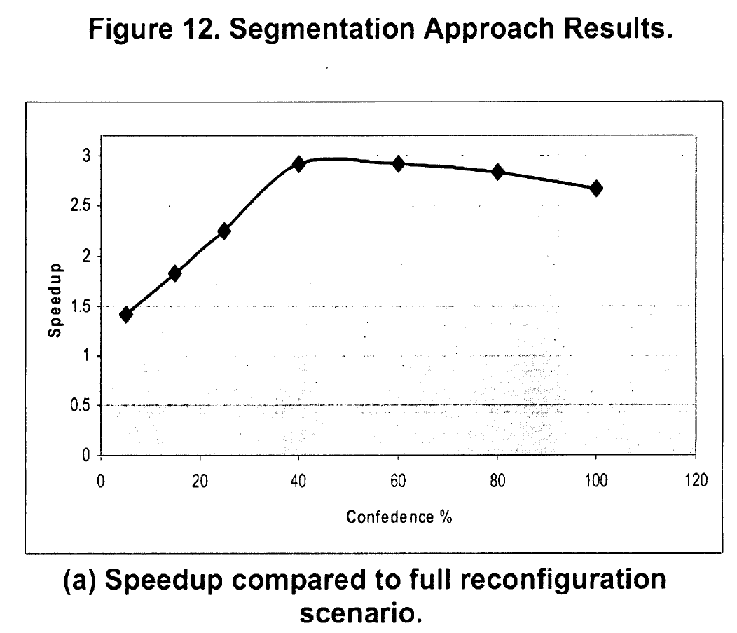

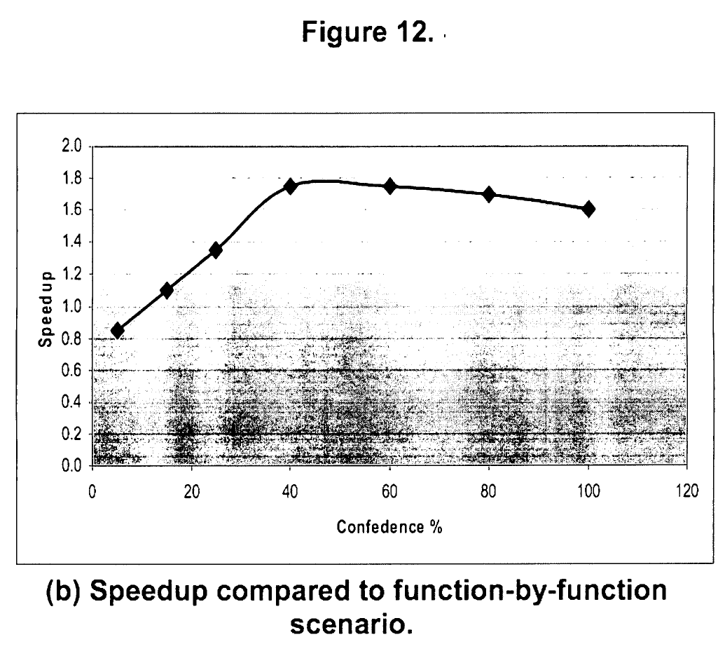

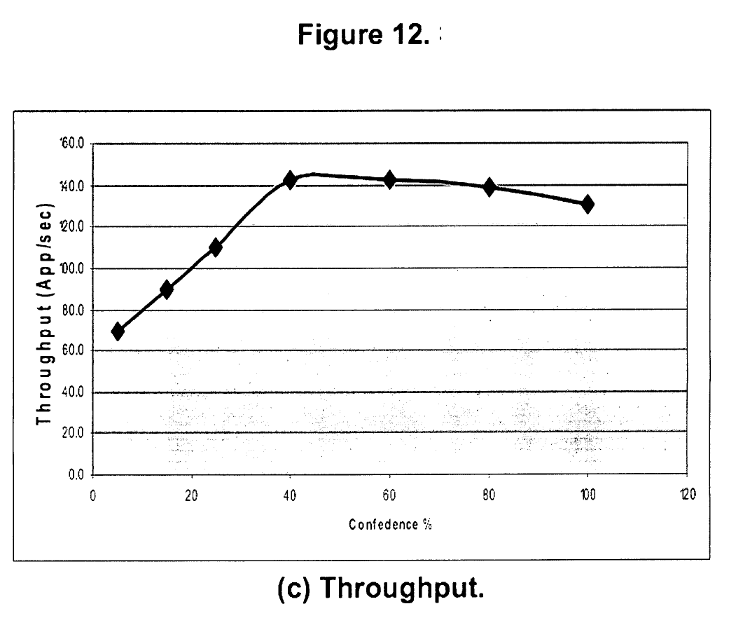

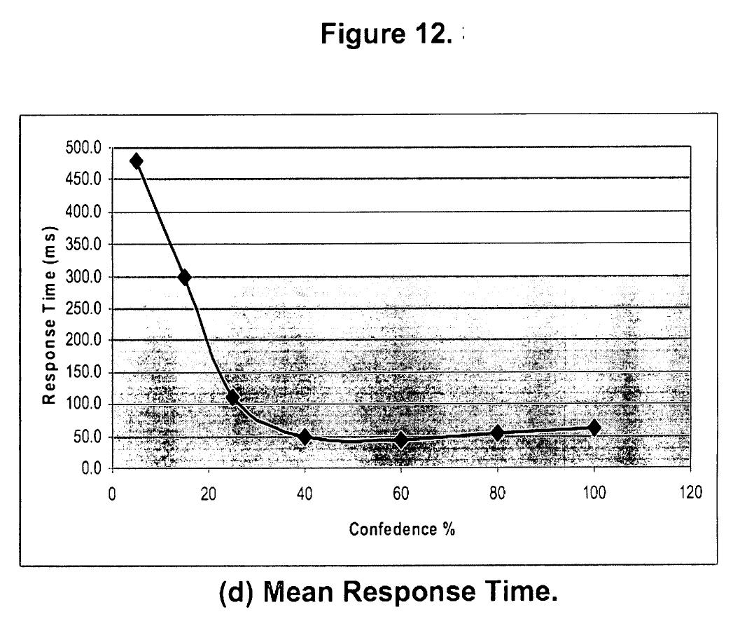

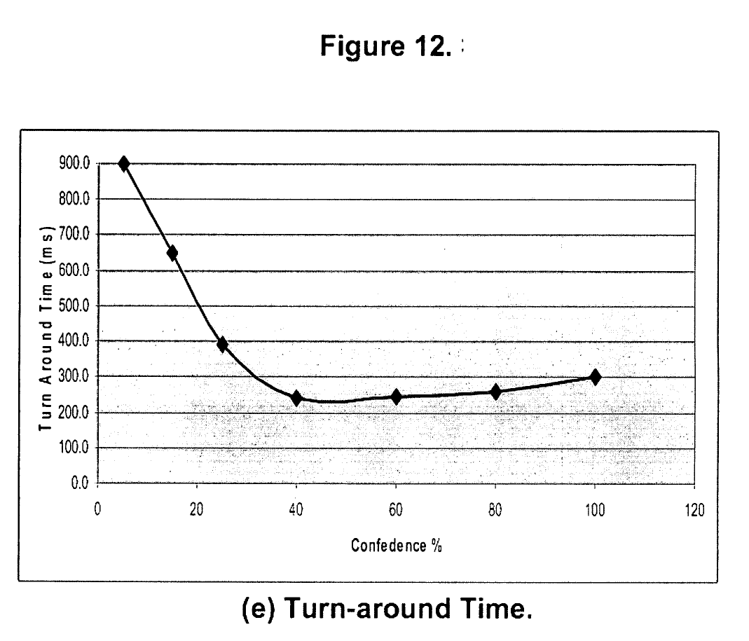

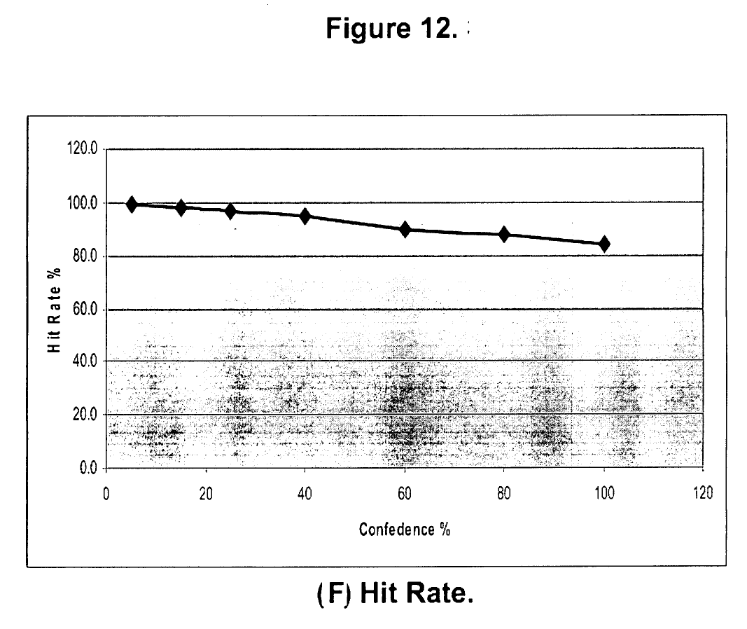

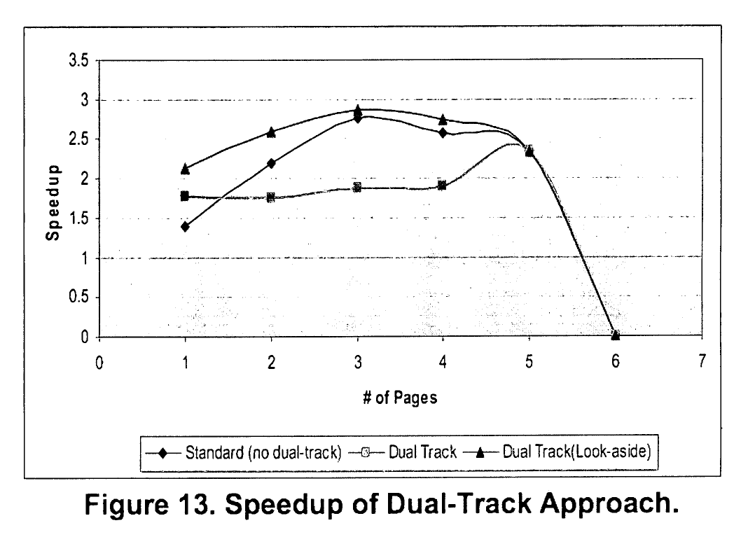

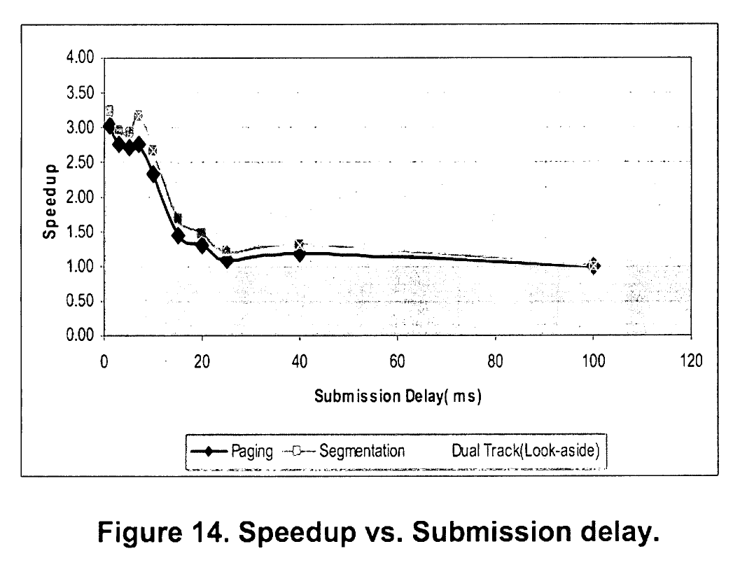

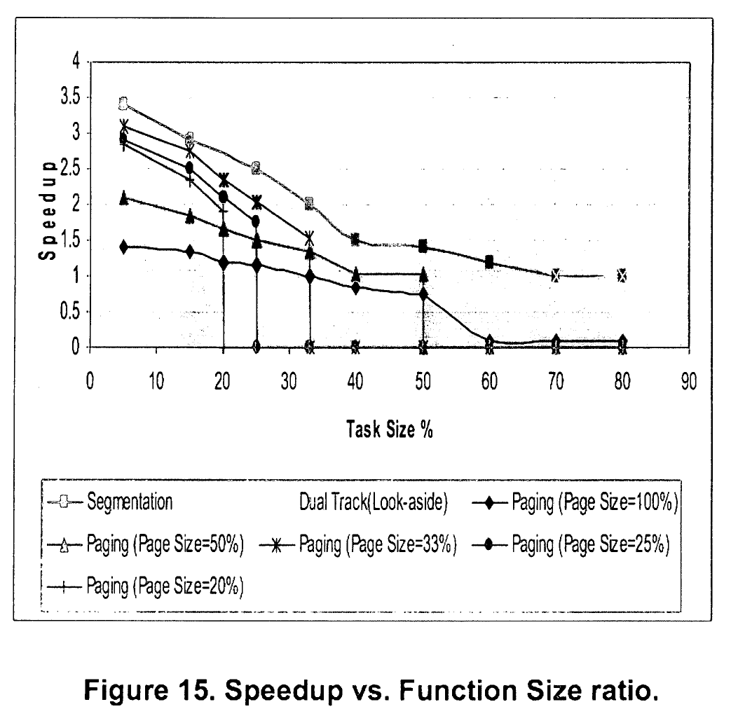

FIG. 10(a) shows the speedup gained using paging compared to the full-reconfiguration hardware implementation for different number of pages and different replacement techniques. A maximum speedup of 2.8× have been achieved. The results show that the best performance can be achieved when the page size is one third of the chip size. When the number of pages is small, we have larger page sizes that can accommodate more functions. In this case, the system exploits only spatial locality and can suffer high configuration penalty. This explains the lower performance when the number of pages is 1. On the other hand when the number of pages is large, the page sizes are small, and cannot accommodate a reasonable number of functions. This explains the drop in performance after the peak. In this case, the system exploits only the temporal locality. The best performance can be observed in the middle of curve when the number of pages is chosen such that they allow a decent number of functions. In this case, the system can take advantage of both temporal and spatial locality at a low configuration penalty cost. This behavior depends on the FPGA size, hardware functions size, average function execution time, and functions arrival rate. Such parameters can be obtained from offline workload characterization and improved from dynamic system profiling. FIG. 10(b) shows the average hit rate versus the number of pages. The hit rate can be defined as the ratio of finding the requested function on the FPGA to the total number of requests. Hit rate depends strongly on the grouping algorithm. If the grouping algorithm managed to group the highly correlated functions in the same group, this will improve the hit rate. Results show that the best hit rate (98%) can be achieved when the number of pages is one, FIG. 10(b), although this does not produce the best performance, FIG. 10(a). This is because the page size is large and the miss penalty (configuration time) is high with big size pages. In both figures, random replacement technique gives poor performance as compared to LRU. FIFO removes the oldest page which might still be in use. LRU achieves the best performance as expected. It removes the pages that have been unused for the longest time. The same set of experiments has been repeated with the same operating conditions and assumptions for the segmentation approach. FIG. 11(a) shows the speedup of segmentation compared to the full-reconfiguration scenario, given different confidence threshold levels. When the confidence threshold is very small, the result is equivalent to paging with one page. In this case, the system exploits spatial locality only. When the confidence is very high, it is difficult to find many functions to group. Thus, the segments become very small, and the system will exploit temporal locality only. The middle case can be observed when the segment size allows for the accommodation of decent number of functions. In this case, the system can take advantage of both temporal and spatial locality. FIG. 11(b) shows the speedup of segmentation compared to function-by-function scenario. The curve behaves similar to FIG. 11(a) for the same reasons. In this case, segmentation has achieved a maximum speedup of 2.95× compared to the full chip reconfiguration scenario, and a speedup of 1.8× compared to the function-by-function implementation scenario. FIGS. 11(c, d, e) show the throughput, the mean response time and the average turn-around time of the application versus the number of pages on the FPGA. The throughput, mean response time, and the average turn-around time of the same experiment using the function-by-function technique are 4 applications/sec, 28.5 sec, and 28.7 sec respectively. FIG. 11(f) shows the average hit rate. A maximum of 98% of the configuration latency overhead has been eliminated. Results show that the best hit rate can be achieved with small confidence threshold, although this does not produce the best performance. This is because the segments size is large and the miss penalty (configuration time) is high with small confidence, while the segment size is small and miss penalty is low with high confidence. FIG. 12 shows the speedup obtained by using dual-track execution paradigm. The first technique, with no functions queue, is not performing well, whiles the second technique, look-ahead, and improves the performance slightly. This shows that it is not always better to execute on microprocessor when the FPGA is not ready. If the FPGA is not ready, two types of overheads may be introduced. The reconfiguration overhead and the scheduling delay overhead. Sometimes it is better to wait to reconfigure the chip than start executing on the microprocessor. If the chip has no space to configure the new function, and we have to wait long time till other functions end, it might be better to start executing on the micro processor. The first technique is not performing well because it execute on microprocessor when the FPGA is not ready. Second technique tries do decide between executing on FPGA or microprocessor depending on which one will finish earlier. This gives us better results. In order to study the effect of the function size and submission delay on performance, a simulation model has been implemented and the experiments have been repeated with different function sizes and different submission delays. FIG. 13 shows the speedup vs. the average applications submission delay for paging, segmentation, and dual-track cases. In this experiment, the FPGA chip was divided into 3 pages, and the average task size was 15% of the chip size. This shows that the performance improves when the system submits applications faster. When submission delay becomes slower, the system waits for new submission. In this case, the system is not benefiting from caching or parallelism and the performance will be similar to the function-by-function case. Thus, the speedup saturates also at 1. FIG. 14 shows the speedup vs. the function size ratio (Avg. function size/chip size) for the same three cases (paging, segmentation, segmentation with dual-track). The experiment has been repeated for the paging case with different page size. This shows that the performance improves when the function size is getting smaller, where pages/segments can accommodate more functions and more parallelism can be exploited. If the function size becomes larger than the page size, the system cannot create page that can accommodate the function, and the application cannot run. Thus, paging algorithm with fixed size page can not work well with all functions size. Segmentation does not have this problem as the segment size can grow up to the chip size. Results show that segmentation performs better than the best paging in all cases by a factor of 30%. Segmentation with dual track execution paradigm improves the performance by another 29%.

### REFERENCES

[1] K. Compton and S. Hauck, “Reconfigurable computing: a survey of systems and software,” ACM Computing Surveys, vol. 34, pp. 171-210, 2002.

[2] Tarek El-Ghazawi, Duncan Buell, Maya Gokhale, Kris Gaj, “Reconfigurable Supercomputing”, SuperComputing Tutorials (SC2004), Pittsburgh, Pa., USA, November 2004.

[3] Tarek El-Ghazawi, “A Scalable Heterogeneous Architecture for Reconfigurable Processing (SHARP)”, Unpublished manuscript, 1996.

[4] Z. Li, K. Compton, Scott Hauck. Configuration Caching Management Techniques for Reconfigurable Computing”. IEEE Symposium on FPGAs for Custom Computing Machines, pp. 87-96, 2000.

[5] Zhiyuan Li, Scott Hauck: Configuration prefetching techniques for partial reconfigurable coprocessor with relocation and defragmentation. FPGA 2002: 187-195.

[6] M. Taher, T. El-Ghazawi, “Exploiting Processing Locality through Paging Configurations in Multitasked Reconfigurable Systems”, Submitted to IEEE Reconfigurable Architecture Workshop (RAW2006).

[7] R. Agarwal, R. Srikanth, “Fast Algorithm for Mining Association Rules”, Proceedings of 20th International Conference on Very large Databases, Santiago, Chile, September 1994.

[8] H. Walder and M. Platzner. Reconfigurable Hardware Operating Systems: From Concepts to Realizations. In Int'l Conf. on Engineering of Reconfigurable Systems and Architectures (ERSA), 2003.

[9] E. El-Araby, M. Taher, T. El-Ghazawi, J. Le Moigne, “Prototyping Automatic Cloud Cover Assessment (ACCA) Algorithm for Remote Sensing On-Board Processing on a Reconfigurable Computer,” Proc. IEEE 2005 Conference on Field Programmable Technology, FPT'05, Singapore.

[10] E. El-Araby, T. El-Ghazawi, J. Le Moigne, and K. Gaj, “Wavelet Spectral Dimension Reduction of Hyperspectral Imagery on a Reconfigurable Computer,” Proc. IEEE 2004 Conference on Field Programmable Technology, FPT 2004, Brisbane, Australia, Dec. 6-8, 2004, pp. 399-402.

[11] M. Taher, E. El-Araby, T. El-Ghazawi, K. Gaj, “Image Processing Library for Reconfigurable Computers”, ACM/SIGDA Thirteenth International Symposium on Field Programmable Gate Arrays (FPGA 2005), Monterey, Calif., USA, February, 2005 (Poster Presentation).

Van der Steen, Aad J. and Jack Dongarra, “Overview of Recent Supercomputers,” 2004.

Cray Inc, Seattle Wash., “Cray XD1 Datasheet”, 2005

The above References are incorporated by reference herein in their entirety.

It will be clear to a person of ordinary skill in the art that the above embodiments may be altered or that insubstantial changes may be made without departing from the scope of the invention. Accordingly, the scope of the invention is determined by the scope of the written description herein, including descriptions of systems, computer architectures, methods, computer readable media associated therewith, as well as the following claims and their equitable Equivalents.

I claim:

1. In a computer architecture with reconfigurable processors, wherein the overall system is adapted to the underlying applications at run-time, wherein not all needed functionalities can be implemented at the same time, the improvement comprising: a configuration management technique based on grouping related functions into fixed size blocks (pages), said Pages are swapped in and out as necessary during application execution, and to address the problem that paging can introduce physical artificial constraints on the functions grouping decision, a technique, called virtual configuration management, that discovers related functions and groups them into variable size blocks (segments), wherein a dual-track execution is provided which allows functions to be performed using either the microprocessor or the reconfigurable hardware, wherein the reconfigurable hardware is sufficiently large such that more than one page or more than one segment can be configured simultaneously.

2. The method of claim 1, where the locality of spatial and temporal processing is exploited in the reconfigurable processor simultaneously.

3. The method of claim 1, further using block replacement strategies to exploit both spatial and temporal processing locality simultaneously.

4. The method of claim 1 wherein the virtual configuration model can provide an increase in processing speed of over previous techniques.

5. A technique to increase the speed of executing complex functions in a computer architecture by allowing functions to be performed using either the microprocessor or the reconfigurable hardware, and executing the most efficient use of the two mechanisms, as described herein.

6. A method of scheduling function processing between software and hardware in a computer architecture using virtual configuration management, as described herein.

7. A system capable of performing the method of any of claims 1, 2, 3, 4, 5, or 6.

8. Computer readable media containing program code for performing the method of any of claims 1, 2, 3, 4, 5, or 6.

9. The media of claim 8, wherein the program code is written in software code languages or hardware description languages.
